(19) United States
(12) Patent Application Publication
(10) Pub. No.: US 2012/0040313 A1
(43) Pub. Date: Feb. 16, 2012

(54) DEVICE AND METHOD FOR DETERMINING THE TARGET POINT OF AN OBSERVATION UNIT, IN PARTICULAR ON A FIREARM SIMULATOR

(75) Inventors: Josef Mullner, Plzen (CZ); Volker Thier, Ilmenau (DE); Martin Markert, Meiningen (DE)

(73) Assignee: E.SIGMA TECHNOLOGY AG, Ilmenau (DE)

(21) Appl. No.: 13/265,939

(22) PCT Filed: Apr. 19, 2010
(86) PCT No.: PCT/EP2010/055113

§ 371 Date: Oct. 24, 2011

(30) Foreign Application Priority Data
Apr. 23, 2009 (EP) 09158664.4

(51) Int. Cl. F41G 3/26; G01B 11/14

(52) U.S. Cl. 434/16; 356/614

(57) ABSTRACT

The invention relates to a device for determining the target point of an observation unit. The device comprises a target area; a scan line projector, which projects at least two non-parallel scan lines and moves said scan lines across the target area; a control unit, which controls the movement of the scan lines; and an optical target point detector, which provides a target point signal to the control unit if a scan line is detected. The control unit determines the position of each scan line 03 in the target area at the time of the detection by the target point detector and outputs the virtual intersection of the two scan lines at said time as the target point. The invention further relates to a method for determining the target point of an observation unit.

### FIELD OF THE INVENTION

The present invention relates to a device and to a method for determining the target point of an observation unit.

### BACKGROUND OF THE INVENTION

To practice the handling of firearms, simulation apparatuses of the greatest variety are used, which are capable of simulating the handling of the weapon and the firing of a shot with varying degrees of realism. In order for the user of such a simulator to be able to obtain feedback indicating whether a simulated shot has actually reached the sighted target, or where the projectile has impacted if an actual shot was fired, appropriate devices and evaluation methods are required, which determine the target point that was sighted at the time when a shot was fired by the marksman, and, in the case of an actual firing of a shot, the place where the projectile impacted, always assuming that the sighting device attached to the simulation weapon, in the case of an error free sighting of the target point, is largely congruent with the point of impact. The deviations between sighting point and point of impact, resulting from ballistics, are not crucial for the considerations below, and are thus not discussed further.

From DE 601 15 445 T2, a firearm laser training system and method is known, which allows a visual feedback in the case of simulated projectile impact points. For this purpose, a firearm simulator is attached to a laser end module, which aims a laser beam on a target when the trigger is actuated. Moreover, a scanning device is provided, which detects an image of the target and of the laser beam projected thereon, and transmits it to a computer system. The points of impact of the laser beam can be displayed to the user, and subjected to additional automated processing.

From DE 10 2004 042 144 A1, a method and a device for shot simulation of weapons aimed directly by means of laser light are known. In this case as well, a laser beam source is provided on the firearm simulator, which aims a laser beam on the sighted target. A portion of the laser light is reflected by reflectors attached to the target, and returned to the firearm simulator. The travel time of the reflected laser beam can be used for determining the distance between the firearm simulator and the target, and other factors.

DE 698 28 412 T2 describes a training weapon that works with a laser, in collaboration with a computer system to determine the target point. When the shot is fired, a laser module attached to the weapon sends a laser beam to a target, and the point of impact of the laser beam on the target is detected by means of detectors, and sent on to a computer system.

The above-mentioned systems which are known from the state of the art have in common that a laser beam module has to be attached to the fire weapon, which module emits a strongly focused laser beam, to the extent that the projection point of the laser beam on the target is employed for the evaluation of the firing accuracy. Consequently, high demands are placed on the laser beam module, particularly if the distances between the firearm and the target are large. If the parallelism of the laser beam is insufficient, the time cannot be determined with high accuracy, because the projection surface of the laser beam is greater than the cross section of the impact of an actual projectile. If laser beams with high parallelism are used instead, then the required laser beam module is technically complicated, leading not only to high costs but also to large dimensions which prevent a realistic reproduction of a firearm simulator. In addition, when using strongly bundled laser beams, special protective measures must be taken, to prevent damage to the eyes of the user or persons in the surroundings, should they be exposed accidentally to the laser beam.

### SUMMARY OF THE INVENTION

The observation unit according to the preamble can be combined with various apparatuses, for example, cameras, visual display units, or firearm simulators. The observation unit according to embodiments of the invention is suitable, for example, for determining the target point or viewing direction of a camera, which is of particular importance for image recording and processing in virtual studios. The observation unit according to embodiments of the invention allows the precise determination of the image area recorded by a camera.

The observation unit according to embodiments of the invention can also be attached to visual display units, in order to determine a detail selected by user in the view field from a projected image. Knowing the sighted image detail makes it possible, for example, to play additional different images on a viewing monitor or a projection surface, depending on the situation or action.

An additional application field for the observation unit according to embodiments of the invention is in the control or monitoring of robots, particularly industrial robots. With regard to the qualities of the task performed by robots, adjustment problems play a primary role which depends on the ability of the robot to move very precisely into a certain spatial position. A very promising path to achieve this is the external monitoring of the robot, and the precise determination of the position thereof in space. For this purpose, it is known to use a multicamera measurement system for a flexible position determination, which allows an increase in the absolute accuracy. The known measurement system works with several high-resolution and calibrated measurement cameras which monitor the work space of the industrial robot. Appropriate target markings are applied on the end effector of the industrial robot, which make it possible to determine the position and orientation of the end effector. The associated technical cost is high. Embodiments of the present invention can also be used advantageously for such position determinations of end effectors on robots.

A special application case of the observation unit, to which reference is made primarily in the following description, is the target point determination on a firearm simulator. However, the person skilled in the art can easily see that the observation unit can also be used for other applications.

One purpose of the present invention thus consists in producing a device and a method for determining the target point of an observation unit, particularly a firearm simulator, which avoids the above-mentioned disadvantages. The purpose is particularly to increase the resolution precision of the target point detection, without a resulting unacceptably high increase in the costs for an appropriate target or for the observation of an image area. At the same time, the invention should make it possible to observe large image areas with precision or to produce large targets on which, for example, a realistic scenario can be depicted, optionally using moving images.

This purpose is achieved by a device according to the attached claim 1 or by a method according to the attached claim 11.

The device according to embodiments of the invention for determining the target point of an observation unit comprises a target monitor, on which at least one target area is defined. The target screen is, for example, a silver screen for projection, or it can be the component of a building or the like. The target screen, and thus also the target area, do not have to be planar; instead, they can be arranged, for example, on a simply or multiply spherically curved surface. Curved projection surfaces make possible a realistic representation of the target images or other objects, allowing, for example, the simulation for a marksman of even far away targets on a target screen that is at a distance of only a few meters. The target area can extend over the entire target screen or encompass only a portion of the target screen.

The device comprises, moreover, a scan line projector which projects at least two nonparallel scan lines simultaneously or with time delay on the target screen, and moves them across said target screen or the target area. Here, it is advantageous not to use any orthogonal scan line and at most one scan line that is parallel to the rotation axis of a deflection mirror of the projector.

In addition, a control unit is provided, which controls and measures the movement of the scan lines, in order to determine when the scan lines enter or exit the target area, and where, within the target area, the scan lines are located at a certain time.

Finally, an optical target point detector is provided, which is attached, for example, to a firearm simulator, a camera or a visual display unit, and aligned with the viewing direction of the corresponding apparatus (for example, with the sighting device of a firearm simulator).

Depending on the application case, the target point detector can observe the target area permanently, or, for example, it may be activated by a simulated firing of a shot, allowing it, in each instance, to deliver a target point signal to the control unit, if it detects a scan line. If the target point detector permanently observes the occurrence of the scan lines, the generated target point signal can be delivered at all times, or only at predetermined times, for example, at the time of the trigger confirmation. For that purpose, in the last mentioned case, it is possible, for example, to deliver the signal which is stored in an intermediate memory, within a predetermined range around the trigger time, to the control unit, when the marksman actuates the trigger of the weapon simulator.

According to a particularly preferred embodiment, the observation unit is designed as a component of a firearm simulator. In modified designs, the observation is used for the detection of a target point of a camera or of another visual display unit. Such visual display units can have a stereoscopic design, in a known manner, wherein the target point detection can be implemented separately for the fields of view of the two eyes. In the sense of the invention, a target point can also be a certain flat detail of a target area, which is detected by the camera or the visual display unit.

The target area is separated preferably by at least two position-determined reference detectors which are struck, in case of moving projection of the at least two nonparallel scan lines, and consequently generate the corresponding reference signals. The reference detectors are also used for autocalibration, because they enable the verification of the position of the scan lines. The reference detectors can also be arranged in embodiment variants outside of the target area, as long as they are reached by the scan lines during a deflection movement.

From the reference signals and from the target point signal delivered by the target point detector, the control unit calculates the position of the scan lines in the target area, for example, at the time when a shot is fired. Subsequently, from the determination of a virtual intersection of the at least two scan lines, the exact position of the target point at the time of the simulated firing of a shot or at a predetermined observation time is determined. Although there is in fact a minimal time delay between the observation time (for example, the time of the firing of the shot) and the detection of the two scan lines by the target point detector, the latter, due to high repetition rates and low processing times, moves at the most in the millisecond range, so that it can be neglected for the determination of the target point, or, in case of high precision requirements, it can be taken into account by calculation.

Depending on the shape of the target area and the detection of the movement of the scan lines in said area, different methods can be used for determining the target point. In the simplest case, the time between the occurrence of the reference signals and the time of the detection of the respective scan line by the target point detector is determined. If the deflection speed is known (for example, from the angular speed of the deflection mirror in the projector), the respective position of the scan lines can be calculated via the time difference.

In an embodiment variant, the beam emission angle for the given scan line can be determined, preferably by detection within the projector. From the width angle and height angle, the position of the scan line on a target plane or also in a three-dimensional space can be determined. This has the advantage that a target point can be determined with precision not only in a plane but also in space. The virtual intersection of the scan lines at the observation time (firing of the shot) is then located on the optical axis between the target point detector and the sighted target point.

It is particularly important for the use of the observation unit according to the invention on a firearm simulator that a laser beam emitting module does not have to be provided on the firearm simulator, rather it can be replaced by a simple optical detector. In this application case, the target point detector has a smallest possible viewing angle, so that its detection region is limited to a very small area of, for example, several square millimeters. At the same time, the target screen or the target area defined thereon can have dimensions of nearly any size, without substantial increase in the complexity of the target point detection.

In other application cases, a high resolution precision of the target point detection can also be achieved without requiring complex position determinations in space, as was the case to date, for example, by projection of a grid pattern.

Since the energy densities of the projected scan lines can be low, health risks to persons in the target area (for example, in the case of use in a virtual studio) can be ruled out. However, the scan line projector is positioned preferably between the target screen and the firearm simulator. Due to this positioning of the scan line projector, one avoids in all cases a direct exposure of the user of the firearm simulator to an impact of the projected laser light.

The scan line projector possesses at least one light source (for example, laser or LED), the beam of which is fanned out in the form of lines, and moved, for example, via a rotating deflection mirror or adjustable mirror, as a scan line across the target area. The construction and mode of operation of such laser scanners are basically known to the person skilled in the art, so that a detailed description of the scan line projector is not necessary. However, it must be noted that, to increase the scan rate, more than two scan lines can also be guided across the target area, wherein different wavelengths, polarizations or modulations of the laser light can be used to prevent mutual influencing of the scan lines.

In a preferred embodiment, four reference detectors are provided, which are each arranged at the corners of a rectangular target area. In this case, if scan lines are used which are not moved parallel to the side edges and to the diagonals of the target area across the latter, the scan lines strike all four reference detectors with a time delay, so that four times are available for determining the reference positions of the scan lines in the target area. The intermediate positions of the scan lines in the target area can be calculated in a simple manner from the known movement speed.

An embodiment variant uses the detected beam emission angle of the scan lines for the position determination.

The scan lines are guided preferably at a high repetition rate across the target area. Using rotating deflection mirrors in the scan line projection, repetition rates of 100 Hz and more can be achieved without difficulty. This means that, per second, more than 50 pairs of scan lines sweep across the target area, where they can be detected by the target point detector. Higher repetition rates can be achieved easily by multiplying the mirror surfaces.

Additional advantages, details and variants of the invention result from the following description of a preferred embodiment of the device according to the invention, and of the basic course of the method to be carried out, for example, by said device, in reference to the drawing. The figures show:

### DESCRIPTION OF THE DRAWINGS

FIG. 1: an overall representation of a device for determining the target point of a firearm simulator; and

FIG. 2: a flow chart of the essential process steps of a method for determining the target point of a firearm simulator.

### DETAILED DESCRIPTION OF THE INVENTION

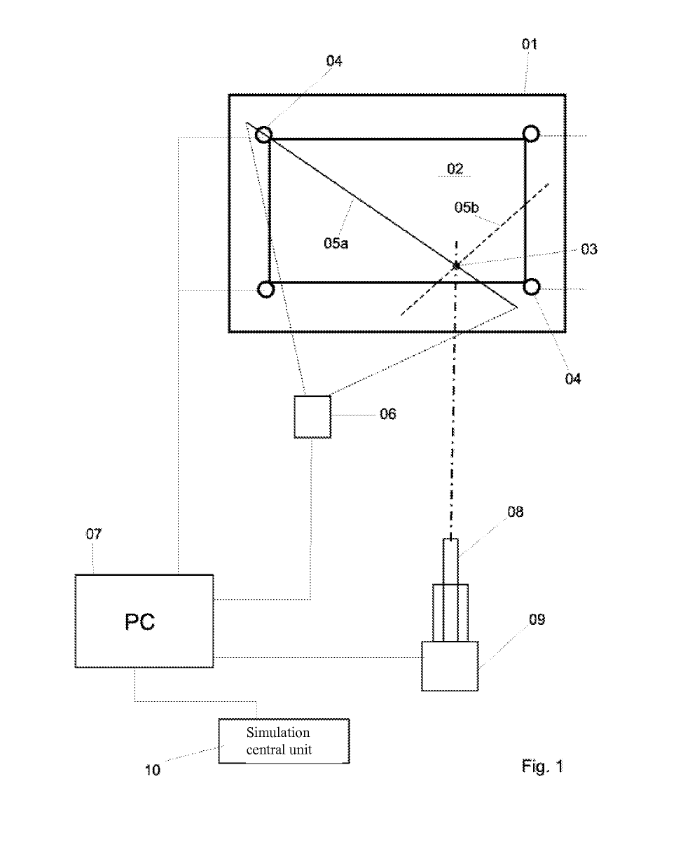

In FIG. 1, the essential elements of a device according to an embodiment of the invention for determining the target point of a firearm simulator as well as their interaction are represented in a simplified manner. The device comprises a target screen 01, which can be designed, for example, as a projection surface with an area of several square meters. In embodiment variants, the target screen can be modified as desired, and present a calculable surface shape, for example, it can have a spherical curvature. On such a projection surface, a conventional target can be drawn or projected. It is also possible to project complex image scenarios on the target screen 01, including moving image sequences. On the target screen 01, at least one target area 02 is defined, in which a target point 03 is sighted by the user.

In the represented embodiment, a total of four reference detectors 04 is provided, which are arranged here at the respective corners of the target area 02. In other embodiments, it is possible to use more or fewer reference detectors which can also be positioned at other places of the target area. The function of the reference detectors consists in determining one or more reference positions on the projection surface relative to the projector. This can occur, for example, by evaluating a common time basis and the reference signals delivered by the reference detectors. In the simplest case, the reference detectors make it possible to define one or more time windows, which can be opened by the entry of a scan line 05 in the target area 02, and closed again by the exit from the target area. By using more than two reference detectors and an appropriate alignment of the scan lines, the target area can here be subdivided into several partial areas.

In the embodiment variant mentioned above, the respective current beam emission angle is determined instead. Said angle can be determined from the known beam emission characteristic of the scan line projector, and from the starting time of a deflection.

The scan lines 05 are generated by a scan line projector 06, projected on the target screen, and moved across the target area 02. In the represented embodiment, the scan line projector 06 is configured as a laser scanner which fans out a laser beam in the form of lines by means of optical elements which in themselves are known, for the purpose of first moving a first scan line 05a across the target area 02, and then also moving a second scan line 05b with changed orientation and 180° phase shift across the target area 02. In embodiment variants, the scan line projector 06 can comprise several laser light sources and/or deflection units.

The two scan lines 05a, 05b can be moved simultaneously or with time delay across the target area 02. They do not extend parallel to each other; instead, they preferably form an angle of 90°. It is particularly advantageous not to project the scan lines parallel to the side edges and to the diagonals of the target area 02, because, in this manner, two reference detectors 04 can never be struck at the same time by a scan line.

A central control unit 07 evaluates the reference signals of the reference detectors 04, and it determines the respective times at which the first and second scan line strikes the respective reference detector. At the same time, the control unit 07 is coupled to the scan line projector 06, in order to cause the projection of the scan lines. From the deflection speed at which the scan lines are guided across the target area 02, the control unit can, simultaneously using the reference signals delivered by the reference detectors 04, calculate at what place of the target area the scan line is located at a certain time. This occurs in a time-based calculation, on the basis of the determined time of the entry into the target area (opening of the time window) or of the impact on an additional reference detector which is struck after the opening of the time window by the scan line. In the modified embodiments, the length angle and the width angle of the scan lines are determined within a scanned target space, in order to determine a spatially defined position of the scan lines.

In the example shown in FIG. 1, the time window is opened when the scan line 05 strikes the first reference detector in its movement path, and closed when the scan line arrives at the fourth reference detector lying in the movement direction. Inbetween, the scan line is tangent to the two other reference detectors, with the result that the accuracy of the position calculation can be increased, which can also be interpreted as the opening and closing of partial time windows.

The device according to embodiments of the invention comprises, moreover, a target point detector 08 which is attached to a firearm simulator 09. The target point detector 08 has at least one optical sensor by means of which the target area 02 is observed, if the firearm simulator 09 is aimed on the target screen 01, and the firing of a shot is simulated. In contrast to image detection systems, the target point detector 08 has as small as possible a viewing angle, so that, even in case of a large distance from the target area, only a small detail of the target area 02 is detected. For focussing, the target point detector 08 can comprise appropriate optics. The area observed by the target point detector 08 corresponds, for example, to the size of an impact opening of a projectile, which would result from an impact at the target point 03. However, the target point 03 can also be determined with greater precision in the case of a larger observation area, by taking into account the signal strength.

The target point 03 is considered to be the place where, at the time of the firing of the shot, the two scan lines 05a, 05b virtually intersect, optionally neglecting the time difference of the projection in case of time-delayed projected scan lines. Because the scanning of the target area 02 with the scan lines 05 is carried out in two directions, a matrix of numerous intersections of the two scan lines is projected virtually on the target area. At the time of the firing of the shot, the target point detector 08 is queried, and, in the case of the time based determination of the position of the scan lines, the control unit 07 determines the time span that has elapsed before the detection of the first scan line 05a and before the detection of the second scan line 05b. Knowing the time signals delivered by the reference detectors 04, and the deflection speed of the scan lines, it is possible to calculate from these values the respective position of the two scan lines at the time of the firing of the shot. The sighted target point 03 corresponds then to the virtual intersection of the two scan lines in the determined position. To clarify, it is pointed out that the scan lines and the target point sighted by the marksman can certainly be in different planes. The optical axis between the target point and the target point detector is intersected by the scan lines. The projection of the intersection of said crossing points is then congruent with that of the target point.

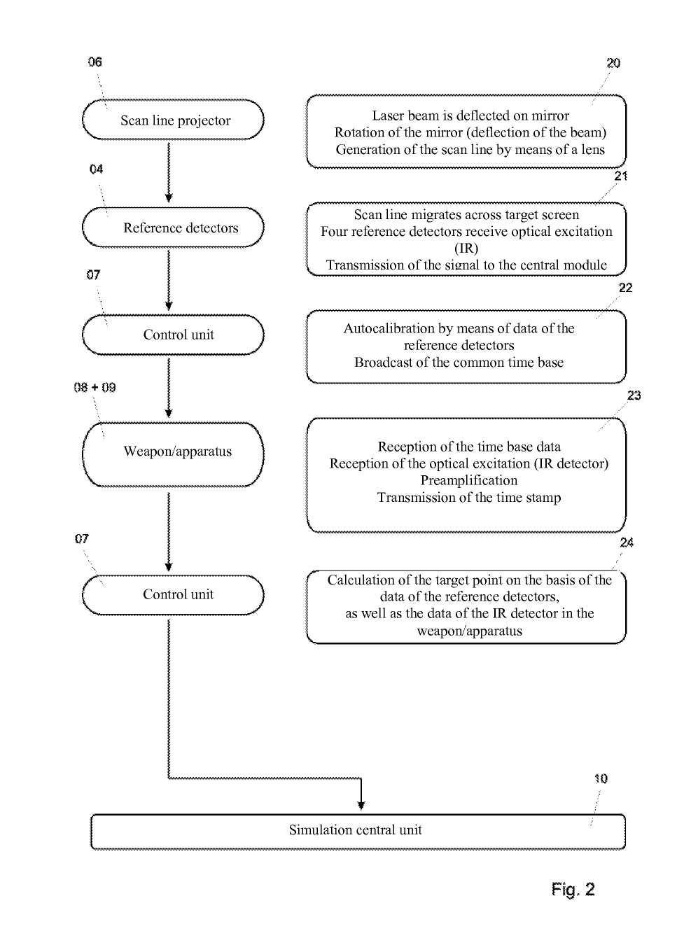

In FIG. 2, the most important steps of the method according to an embodiment of the invention are represented again, in the form of a flow chart, and associated in each case with the corresponding unit of the above-described device, which is responsible for performing these steps. For the projection of at least two scan lines on the target screen, in step 20, a laser beam is deflected first, for example, on a rotating mirror or a similar element, to generate the scan lines. In step 21, the scan lines are moved across the target screen, and in the process they strike the reference detectors 04 which then transmit the reference signal to the control unit 07. In step 22, an autocalibration of the entire device can occur, with evaluation of the reference signals delivered by the reactor detectors, and use of a common time basis generated, for example, in the control unit 07, and distributed to the other units.

In step 23, the firearm simulator 09 receives the common time basis, and, when a shot is triggered, it detects the projected scan lines by means of the target point detector 08. The times of the detection of the scan lines are transmitted, for example, in the form of a timestamp to the control unit 07. In step 24, the latter then calculates the target point, in the above-described manner, using the determined time data.

Since the device for determining the target point in the described application works in collaboration with the firearm simulator, data coupling between the control unit 07 and a simulation central unit 10 is advantageous. The simulation central unit 10 takes over additional control functions for the firearm simulator.

In the claims:

1. A device for determining a target point of an observation unit, comprising:
a scan line projector to project at least two nonparallel scan lines simultaneously or with time delay, and to move the scan lines across a target area;
a control unit to control the movement of the scan lines; and
an optical target point detector to, in each case, deliver a target point signal to the control unit if a scan line is detected;
wherein the control unit is configured to determine the position of each scan line in the target area at a time of the detection by the target point detector, and to output a virtual intersection of the two scan lines at the time of the detection as a target point.

2. The device according to claim 1, configured for determining the target point of a firearm simulator, wherein the optical target point detector is attached to a firearm simulator and provided with a sighting device thereof; and such that the target point signal is delivered by means of at least one simulated firing of a shot to the control unit, if a scan line is detected.

3. The device according to claim 1, further comprising at least two reference detectors which are struck by the scan lines during their movement, and which are configured to deliver reference signals to the control unit.

4. The device according to claim 3, wherein the control unit, from the reference signals and from times elapsed between their occurrence, is configured to determine the position of each scan line in the target area at the time of the detection by the target point detector.

5. The device according to claim 3, wherein four reference detectors are arranged at the corners of a rectangular target area, wherein the two scan lines are not moved parallel to the side edges or to the diagonals of the target area, so that they strike all four reference detectors temporally one after the other.

6. The device according to claim 1, wherein the scan line projector determines the deflection angle at which the scan lines are projected towards the target area, and such that the control unit determines, from the detected deflection angles, the position of each scan line in the target area at the time of the detection by the target point detector.

7. The device according to claim 1, wherein the scan line projector comprises at least one laser light source and one deflection unit which generates, for the generation and movement of the scan lines, a laser beam which is fanned in the form of lines, and the deflection unit further removing the scan lines across the target area.

8. The device according to claim 7, wherein the scan line projector uses two laser light sources with different wavelengths, polarizations or modulations for the generation of the scan lines.

9. The device according to claim 1, wherein the scan lines are guided at a repetition rate of more than 100 Hz across the target area.

10. A method for determining the target point of an observation unit, comprising the following steps:
projecting of at least two nonparallel scan lines simultaneously or with time delay on a target screen;
moving the scan lines in a predetermined target area of the target screen at a predetermined movement speed;
detecting of the two scan lines with an optical target point detector;
determining the position the respective scan lines in the target area at the time of the detection by the target point detector; and
determining determination the target point as an intersection of the two scan lines at the time of the detection by the target point detector.

11. The method according to claim 10, where the method is employed for determining the target point of a firearm simulator, and wherein the detection of the two scan lines is carried out with an optical target point detector attached to a firearm simulator and aligned with a sighting device thereof, at a time of a simulated firing of a shot.

12. The method according to claim 10, further comprising determining times at which the scan lines enter or exit the target area, and a time span between said times, and a deflection speed, and employing these determined quantities in the determination of the position of the respective scan line in the target area at the time of the detection by the target point detector.

13. The method according to claim 10, wherein the position of the respective scan line in the target area is determined on a basis of spatial angles of the scan line at the time of the detection by the target point detector.

14. The method according to claim 10, wherein the two scan lines are projected at a right angle to each other on the target screen.

15. The method according to claim 10, wherein the two scan lines are projected alternately on the target screen temporally one after the other.

16. The device according to claim 2, further comprising at least two reference detectors which are struck by the scan lines during their movement, and which are configured to deliver reference signals to the control unit.

17. The device according to claim 4, wherein four reference detectors are arranged at the corners of a rectangular target area, wherein the two scan lines are not moved parallel to the side edges or to the diagonals of the target area, so that the two scan lines strike all four reference detectors temporally one after the other.

18. The method according to claim 11, further comprising determining times at which the scan lines enter or exit the target area, and a time span between said times, and a deflection speed, and employing these determined quantities in the determination of the position of the respective scan line in the target area at the time of the detection by the target point detector.

19. The method according to claim 11, wherein the position of the respective scan line in the target area is determined on a basis of spatial angles of the scan line at the time of the detection by the target point detector.

20. The device according to claim 2, wherein the scan line projector determines the deflection angle at which the scan lines are projected towards the target area, and such that the control unit determines, from the detected deflection angles, the position of each scan line in the target area at the time of the detection by the target point detector.
